(19) United States
(12) Patent Application Publication
(10) Pub. No.: US 2024/0333832 A1
(43) Pub. Date: Oct. 3, 2024

(54) METHOD OF DETERMINING VOICE QUALITY OF VOICE CALL AND SYSTEM FOR USING THE SAME

(71) Applicant: Rakuten Symphony India Private Limited, Indore (IN)

(72) Inventors: Mukesh PAWAR, Indore (IN); Ankit PASHINE, Indore (IN); Ankit RATHORE, Indore (IN); Dharmendra JAIN, Indore (IN); Sandeep RATHOR, Indore (IN)

(21) Appl. No.: 18/190,959

(22) Filed: Mar. 27, 2023

(51) Int. Cl. H04M 3/22; H04L 43/0829; H04L 43/0852

(52) U.S. Cl. CPC H04M 3/2236; H04L 43/0829; H04L 43/0852

(57) ABSTRACT

A voice quality determination system includes a display; a non-transitory computer readable medium configured to store instructions thereon; and a processor connected to the non-transitory computer readable medium and the display. The processor is configured to execute the instructions for receiving voice data of a voice call made over a network of a mobile network operator, the voice data being divided into packets for transmission in the network. The processor is configured to execute the instructions for, in response to receiving the voice data, determining a voice quality of the voice call based on: a packet loss indicating a packet of the packets failing to be transmitted during the transmission and a delay that occurred during the transmission. The processor is further configured to execute the instructions for instructing the display to display a result of a determination of the voice quality.

### BACKGROUND

Calling is a basic feature for a mobile network operator to serve users or consumers. In traditional voice networks, voice calls are transmitted over dedicated circuits, which can lead to network inefficiencies. With development of telecommunication network, a technology for voice communication over a 4G LTE data network, namely VOLTE (Voice over Long-Term Evolution), has been implemented. This technology enables voice calls to be transmitted over the internet protocol (IP) networks instead of traditional circuit-switched voice networks. Although voice quality of VOLTE calls is generally considered to be better than the traditional voice calls, there are multiple factors that have impacts on the voice quality of VOLTE calls. Checking the voice quality of VOLTE calls is therefore a challenging task for the mobile network operator.

### SUMMARY

In at least one embodiment, a voice quality determination system includes a display; a non-transitory computer readable medium configured to store instructions thereon; and a processor connected to the non-transitory computer readable medium and the display. The processor is configured to execute the instructions for receiving voice data of a voice call made over a network of a mobile network operator, the voice data being divided into packets for transmission in the network. The processor is configured to execute the instructions for, in response to receiving the voice data, determining a voice quality of the voice call based on: a packet loss indicating a packet of the packets failing to be transmitted during the transmission and a delay that occurred during the transmission. The processor is further configured to execute the instructions for instructing the display to display a result of a determination of the voice quality.

In at least one embodiment, a voice quality determination method includes receiving voice data of a voice call made over a network of a mobile network operator, the voice data being divided into packets for transmission in the network. The method further includes in response to receiving the voice data, determining a voice quality of the voice call based on a packet loss indicating a packet of the packets failing to be transmitted during the transmission and a delay that occurred during the transmission. The method further includes displaying a result of a determination of the voice quality.

In at least one embodiment, a non-transitory computer readable medium is configured to store instructions for causing a processor executing the instructions to implement a voice quality determination method. The instructions cause the processor to receive voice data of a voice call made over a network of a mobile network operator, the voice data being divided into packets for transmission in the network. The instructions further cause the processor to, in response to receiving the voice data, determine a voice quality of the voice call based on a packet loss indicating a packet of the packets failing to be transmitted during the transmission and a delay that occurred during the transmission. The instructions further cause the processor to displaying a result of a determination of the voice quality.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram showing a method of determining an Estimated Mean Opinion Score (EMOS) in accordance with some embodiments.

FIG. 2 is a flowchart of a method of determining a quality of a voice call in accordance with some embodiments.

FIG. 3 is a flowchart of a method of implementing a voice quality determination system to determine a quality of a voice call in accordance with some embodiments.

FIG. 4A is a diagram illustrating an example of a user interface of a voice quality determination system in accordance with some embodiments.

FIG. 4B is a diagram illustrating an example of a user interface of the voice quality determination system in accordance with some embodiments.

FIG. 4C is a diagram illustrating an example of a user interface of the voice quality determination system in accordance with some embodiments.

FIG. 4D is a diagram illustrating an example of a user interface of the voice quality determination system in accordance with some embodiments.

FIG. 4E is a diagram illustrating an example of a user interface of the voice quality determination system in accordance with some embodiments.

FIG. 4F is a diagram illustrating an example of a user interface of the voice quality determination system in accordance with some embodiments.

FIG. 5A is a diagram illustrating an example of a further user interface of a voice quality determination system in accordance with some embodiments.

FIG. 5B is a diagram illustrating an example of a further user interface of a voice quality determination system in accordance with some embodiments.

FIG. 6 is a block diagram of a system for implementing determination of a quality of a voice call in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Mean Opinion Score (MOS) is widely used for a mobile network operator to measure the quality of voice communication in Voice over Long-Term Evolution (VOLTE) and other voice services. MOS is a numerical score that ranges from 1 to 5, where 5 represents the best possible voice quality and 1 represents the worst. A MOS value is typically obtained by implementing a software or an application, which is able to fetch a recorded voice data file stored in a memory of a mobile device and then run the voice data file to calculate a MOS value. That is, the mobile network operator downloads a voice file and then runs a MOS calculation software to measure a quality of voice communication in a network. The process of checking the voice quality is time consuming so that it takes time for the mobile network operator to be aware of a voice quality issue. Thus, the efficiency in maintaining the network will be reduced. In addition, if the issue goes unresolved for an extended period of time, customer satisfaction will be reduced and a risk of losing customers increases.

Furthermore, a cost of using a MOS calculation software or application for checking the voice is typically a concern for mobile network operators. When a large number of devices are required to install such software or application, the cost for obtaining a software license for each of the devices is high.

In accordance with some embodiments described in the disclosure, a method is able to determine a quality of voice communication in a network by using real-time event capture from a mobile device during a test call. A system of using the method obtains voice data of a test call in real time and calculates an Estimated Mean Opinion Score (EMOS) value to determine a voice quality of the call. This system improves the efficiency in maintaining the network. Further, in some embodiments of the description, the system allows multiple users or clients to see details of the test call and to check a result of the determined EMOS value from external devices. In such a case, the mobile network operators do not need to pay for an expensive licensed software/application and the cost for checking the quality of a voice communication in the network is substantially reduced.

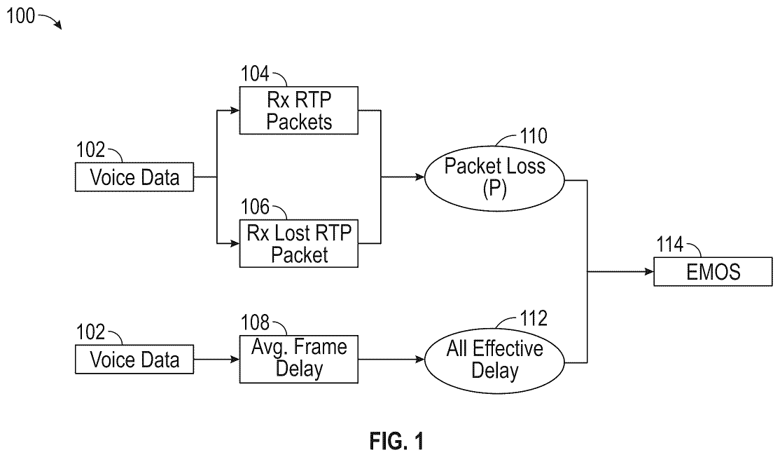

FIG. 1 is a schematic diagram showing a method of determining an Estimated Mean Opinion Score (EMOS) in accordance with some embodiments. In some embodiments, the method 100 is usable by a mobile network operator in order to determine a quality of voice communication in the network. In some embodiments, the network is 4G LTE network. In some embodiments, the network is a mobile communication network different from 4G LTE network. The method is also usable to determine whether service or maintenance on the network is likely warranted based on a result of a determination of the voice quality. This allows the mobile network operator to make more informed decisions regarding whether service or maintenance of the network is warranted. In some embodiments, the method 100 is implemented using an application installed on a mobile device. In some embodiments, the method 100 is implemented by collecting data by the mobile device and processing the collected data. In some embodiments, some collected data is processed by the mobile device and some collected data is processed by an external device.

The method 100 obtains voice data 102 transmitted in a mobile communication network from a sender to a receiver. In some embodiments, a sender is a mobile device that has a chipset that supports the mobile communication network capabilities. In some embodiments, a receiver is a mobile device that has a chipset that supports the mobile communication network capabilities or a server that processes data received from the sender. In some embodiments, the voice data 102 is collected while the call is being made. In some embodiments, the voice data 102 is obtained from a data file saved in a memory of the mobile device.

The voice data 102 is divided into a series of packets transmitted over the network. In some embodiments, the method 100 obtains Rx RTP packets 104, i.e., Received Real-Time Transport Protocol packets, which are the units of data that are transmitted using the RTP packets. The Rx RTP packets 104 represent an amount of packets that are successfully transmitted from the sender to the receiver over the network.

During data transmission from the sender to the receiver, some packets fail to be transmitted to a destination, e.g., the receiver, over the network, thus packet loss occurs. Packet loss occurs due to a variety of reasons, including but not limited to, problems with network equipment, errors in the transmission media, or network congestion. The method 100 further obtains lost RTP packets 106, which represents an amount of packets that fail to be successfully transmitted from the sender to the receiver over the network.

The method 100 determines a value of Packet Loss 110 based on the Rx RTP Packets 104 and the Rx Lost RTP packets 106. In some embodiments, the method 100 determines a percentage value (P) of the Packet Loss 100 according to a formula:

$$Packet Loss ( P ) = ( Rx Lost RTP packets / Total Tx RTP packets ) \times 100 \%$$

where a value of total Tx RTP packets, i.e., Transmitted Real-Time Transport Protocol packets, is determined by adding the Rx Lost RTP packets 104 and the Rx RTP packets 106.

The method 100 further uses the voice data 102 to determine an average frame delay 108, which is an average time for a frame of data to be transmitted from the sender to the receiver. The average frame delay 108 is a measure of the performance of the network. In some embodiments, the average frame delay 108 is calculated or determined by measuring the time it takes for a frame of data to travel from the sender to the receiver over the network and averaging the time over a number of data frames transmitted over the network.

The method 100 determines an overall effective delay 112 that occurred in the data transmission from the sender to the receiver in the network. The overall effective delay 112 includes all effective delay in data transmission from the sender to the receiver. In some embodiments, one or more other delays in data transmission are considered as part of the overall effective delay 112. For instance, other delays include a processing delay, which is the time for processing the data, including at least one of encoding, decoding, compression, encryption, or error correction. In some embodiments, the processing delay refers to the time it takes for both the sender and receiver to process the data. In some embodiments, the processing delay refers to the time for only the receiver or the sender to process the data. In some embodiments, the other delays in data transmission further include a packetization delay, which is the time for dividing the voice data into packets and preparing the packets for transmission in the network.

The method 100 determines an EMOS 114 based on the Packet Loss 110 and the overall effective delay 112. In some embodiments, the EMOS 114 is determined as the voice call is being made, i.e., the voice data is obtained while the voice call is in process. In some embodiments, the EMOS 114 is determined based on the voice data obtained from a data file stored in a memory of a mobile device.

A value of the determined EMOS 114 indicates a voice quality of the voice call. In some embodiments, the EMOS 114 is a numerical score that ranges from 1 to 5, where 5 represents the best possible voice quality and 1 represents the worst. In some embodiments, an EMOS value of 4 or higher is considered to indicate a high-quality voice call, while an EMOS value of 3 or lower is considered to indicate that the voice quality of the call is poor.

The method 100 is usable by a mobile network operator to help determine how to respond to information related to service of the network. In some embodiments, in response to the EMOS 114 being in a range of 1-3, a report that the voice quality is poor or the voice quality needs improvement is generated by the device that implements the method 100. In some embodiments, the report is transmitted to an external device, e.g., a server. In some embodiments, the report includes an audio or visual alert on the device. In some embodiments, the report is automatically displayed on a display of the device.

In some embodiments, in response to receiving the report, the mobile network operator issues instructions for improving the voice quality of the voice call service at the location of the mobile device. In some embodiments, the instructions are generated automatically without user interaction.

In some embodiments, in response to receiving the report, the mobile network operator issues instruction for performing network optimization to improve voice quality by reducing the amount of data congestion delay and reducing the amount of packet loss.

In some embodiments, in response to receiving the report, the mobile network operator issues instruction for checking the user's mobile device compatibility. For instance, the mobile network operator sends a message with instructions to the user's mobile device to guide the user to check whether the mobile device is compatible with the voice call service, e.g., VOLTE service and whether the mobile device has a compatible microphone and speaker for clear voice transmission.

In some embodiments, in response to receiving the report, the mobile network operator checks codecs, which are used for compressing and decompressing voice data for transmission over the network. Each of the codecs has a predetermined parameter value that affects the voice quality of the voice call. In some embodiments, a different codec is reselected automatically in response to receiving the generated alert or warning notification. In some embodiments, a different codec is reselected in response to a request or a command from the mobile network operator.

In accordance with some embodiments described in the disclosure, the method 100 is able to determine an EMOS for determining a quality of voice communication in a network by using real-time event capture from a mobile device during a voice call. The method obtains voice data of a voice call and determine an EMOS in real time based on a packet loss amount and an overall delay amount determined from the obtained voice data to determine a voice quality of the voice call. This method improves the accuracy of the determination as the data analysis is processed in near real time while collecting the data. Further, this method helps the mobile network operator to make faster and more informed decisions to solve any issues that cause a poor quality of the voice call service such that efficiency in maintaining the network is improved or customer satisfaction is maintained or improved.

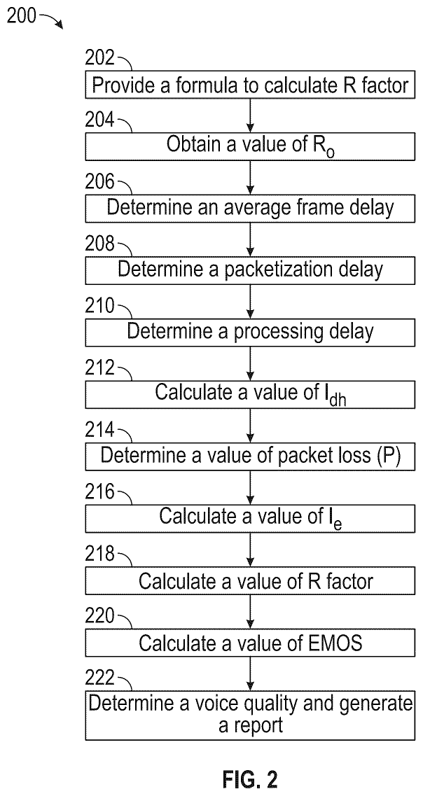

FIG. 2 is a flowchart of a method 200 of determining an Estimated Mean Opinion Score (EMOS) in accordance with some embodiments. In some embodiments, the method 200 is usable with the method 100 (FIG. 1) by a mobile network provider to determine a voice quality of a voice communication made over a network. In some embodiments, the method 200 is implemented using an application installed on a device, e.g., a receiver, by collecting data from a device, e.g., a sender, and processing the data.

The method 200 includes operation 202 in which a formula (a) for calculating an R factor is provided:

$$R Factor Calculation Formula R = {R}_{o} - {I}_{d h} - {I}_{e} ,$$

where R factor represents an overall network quality rating. The R factor is a measure of the signal-to-noise ratio (SNR) of the data transmission in the network. In some embodiments, the R factor has a numerical range between 0 and 100. The parameter Rₒ represents a signal-to-noise ratio (SNR). The parameter I_{dh} represents an overall effective delay. The parameter Iₑ represents an effectiveness of equipment of the mobile network operator. In some embodiments, the formula (a) is stored in a memory of the mobile device implementing the method 200.

The method 200 proceeds to operation 204 from operation 202 to obtain a value of parameter Rₒ. The parameter Rₒ, which is the signal-to-noise ratio (SNR), affects the quality of the network connection and indicates a level of radio frequency interference in an overall network quality. The higher the signal-to-noise ratio, the better the quality of the network connection signal that can be achieved. The mobile network provider monitors the signal-to-noise ratio of the network. In operation 204, a value of the signal-to-noise ratio is obtained from the mobile network provider. In some embodiments, a value of the signal-to-noise ratio is 93.2. In some embodiments, a value of the signal-to-noise ratio is different from 93.2.

In response to the value of the signal-to-noise ratio being obtained in operation 204, the method 200 proceeds to operation 206 in which an average frame delay is determined. In some embodiments, an average frame delay is determined according to method 100 (FIG. 1), i.e., the average frame delay is calculated or determined by measuring the time it takes for a frame of data to travel from the sender to the receiver over the network and averaging the time over a number of data frames transmitted over the network. In some embodiments, an average frame delay is determined by a different calculation.

In response to the average frame delay being determined in operation 206, the method 200 proceeds to operation 208 in which a packetization delay is determined. The packetization delay refers to the time it takes to divide a large block of data, i.e., the voice data, into small packets for transmission over a network. In some embodiments, the packetization delay is calculated by subtracting the time it takes to transmit the data from the time to process the data into packets. In some embodiments, the packetization delay is calculated by further subtracting the time to perform other processing, e.g., adding headers to the packets.

In response to the packetization delay being determined in operation 208, the method 200 proceeds to operation 210 in which a processing delay is determined. In some embodiments, the processing delay refers to the time to process the data as it is being transmitted from the sender to the receiver. Tasks for processing data includes, but not limited to, error checking, compression, and/or encryption. The processing delay is calculated by subtracting the time of transmitting the data from the time of performing the tasks of processing the data. In some embodiments, the processing delay is obtained by a different manner.

The method 200 proceeds to operation 212 from operation 210. In operation 212, a value of the parameter I_{dh} is calculated. In some embodiments, the parameter I_{dh} is calculated according to a formula (b):

$${I}_{d h} = 0 \text{.024} \times {I}_{d} ,$$

where 0.024 is a predetermined value, and I_{d} is a total delay in the data transmission from the sender to the receiver over the network. In some embodiments, the total delay I_{d} is calculated by adding the average frame delay determined at operation 206, the packetization delay determined at operation 208, and the processing delay determined at operation 210. In some embodiments, the total delay is calculated by adding the average frame delay determined at operation 206, the packetization delay determined at operation 208, the processing delay determined at operation 210, and one or more other delays that are occurred during the data transmission. In some embodiments, the total delay I_{d} is value in millisecond (ms).

In response to the overall delay being calculated in operation 212, the method 200 proceeds to operation 214 in which a value of Packet Loss is determined. In some embodiments, a value of Packet Loss P is a percentage value P of the Packet Loss according to a formula (d):

$$Packet Loss ( P ) = ( Rx Lost RTP packets / Total Tx RTP packets ) \times 100 \%$$

where a value of total Tx RTP packets, i.e., Transmitted Real-Time Transport Protocol packets, is determined by adding the Rx Lost RTP packets and the Rx RTP packets. The values of the Rx Lost RTP packets and the Rx RTP packets are obtained in a manner similar to method 100 (FIG. 1). In some embodiments, the value of Packet Loss P is calculated in a different manner.

In response to the Packet Loss being determined in operation 214, the method 200 proceeds to operation 216 in which a value of the parameter Iₑ is determined. The parameter Iₑ represents an effect of equipment of the mobile network operator.

In some embodiments, the parameter Iₑ is determined based on packet loss and parameters associated with a codec used by the mobile network operator for processing data. In some embodiments, a value of the parameter Iₑ is calculated by a formula (c):

$${I}_{e} = a + b \times ln ( 1 + cP / 100 )$$

where a, b, and c represent parameters associated with a codec, and P represents Packet Loss.

The codec is a compression/decompression algorithm that is used to digitally encode and decode audio signals. An example of codec PCMU defined by G711 standard with associated parameters is provided in Table 1 below.

TABLE 1

| | Parameter | Parameter | Parameter | Processing | Packetization |
|---|---|---|---|---|---|
| Codec | a | b | c | delay | delay |
| PCMU | 0 | 30 | 15 | 5 | 20 |
| (G711) | | | | | |

As shown in Table 1 above, as to codec PCMU, parameters a, b, c, are predetermined values 0, 30, and 15, respectively, the processing delay associated with the codec PCMU has a value of is 5, and the packetization delay has a value of 20. The values in Table 1 are mere examples and are not intended to limit the scope of this description or override discussions of different values or adjusting values above.

In some embodiments, operation 214 determines the parameter Iₑ based on the parameters a, b, and c associated with codec PCMU, which is used in North America and Japan. In some embodiments, codec PCMA defined by G711A standard is used in Europe, Australia, and other countries and is used in operation 214 to determine a value of the parameter Iₑ.

In response to the value of the parameter Iₑ being determined in operation 216, the method 200 proceeds to operation 218. In operation 218 according to some embodiments, a value of R factor is calculated based on the formula (a) provided at operation 202: R=Rₒ−I_{dh}−Iₑ. The values of Rₒ, I_{dh}, and Iₑ are obtained at operations 204, 212, and 216, respectively.

In response to the value of the R factor being calculated in operation 218, the method 200 proceeds to operation 220. In operation 220, a value of EMOS is calculated. In some embodiments, an EMOS is calculated according to a formula (e):

$$EMOS = 1 + ( 0.0 \; 35 \times R ) + R \times ( R - 60 ) \times ( 100 - R ) \times 7 \hat{} ( - 6 ) ,$$

where R is calculated according to the formula (a) in operation 218. In some embodiments, the formula (e) is stored in a memory of the device implementing the method 200.

In response to the EMOS value being determined in operation 220, the method 200 proceeds to operation 222 in which a voice quality of a voice call based on the EMOS value is determined and a report of the determined voice quality is generated. In some embodiments, the EMOS is a numerical score that ranges from 1 to 5, where 5 represents the best possible voice quality and 1 represents the worst. In some embodiments, an EMOS value of 4 or higher is considered to indicate a high-quality voice call, while an EMOS value of 3 or lower is considered to indicate that the voice quality of the call is poor. The thresholds above are examples and are not intended to limit the scope of this description or override discussions of different thresholds or adjusting thresholds above.

In some embodiments, in response to the calculated EMOS being in a range of 1-3, a report that the voice quality is poor or the voice quality needs improvement is generated in operation 222 of the method 200. In some embodiments, the report is further transmitted to an external device, e.g., a server. In some embodiments, the report includes an audio or visual alert on the mobile device. In some embodiments, the report is automatically displayed on a display of the device implementing the method 200. The method 200 is usable by a mobile network operator to help determine how to respond to information related to service of the network.

In some embodiments, in response to receiving the report, the mobile network operator issues instructions for improving the voice quality of the voice call service at the location of the mobile device. In some embodiments, the instructions are generated automatically without user interaction.

In some embodiments, in response to receiving the report, the mobile network operator issues instruction for performing network optimization to improve voice quality by reducing the amount of data congestion delay and reducing the amount of packet loss.

In some embodiments, in response to receiving the report, the mobile network operator issues instruction for checking the user's mobile device compatibility. For instance, the mobile network operator sends a message with instructions to the user's mobile device to guide the user to check whether the mobile device is compatible with the voice call service, e.g., VOLTE service and whether the mobile device has a compatible microphone and speaker for clear voice transmission.

In some embodiments, in response to receiving the report, the mobile network operator checks codecs, which are used for compressing and decompressing voice data for transmission over the network. Each of the codecs has a predetermined parameter value that affects the voice quality of the voice call. In some embodiments, a different codec is reselected automatically in response to receiving the generated alert or warning notification. In some embodiments, a different codec is reselected in response to a request or a command from the mobile network operator.

One of ordinary skill in the art would recognize that additional operations are included in method 200 in some embodiments. For example, in some embodiments, a determination of another metric that has impact on the voice quality is included in the method 200. In some embodiments, at least one operation is omitted from the method 200. For example, in some embodiments, the operation 206 of determining a processing delay or the operation 208 of determining a packetization delay is omitted from the method 200. In some embodiments, an order of operations of the method 200 is adjusted. For example, in some embodiments, operations 214 and 216 are performed prior to operations 206, 208, 210, 212. In some embodiments, operations 206, 208, 210, 212 and operations 214 and 216 are performed independently at the same time.

In accordance with some embodiments described in the disclosure, the method 200 is able to determine a quality of voice communication over a network by using real-time event capture from a mobile device. In some embodiments, the method 200 is implemented using a predetermined formula to calculate an R factor. In some embodiments, the method 200 is implemented using a predetermined formula to calculate an EMOS based on the calculated R factor. In some embodiments, the method 200 is implemented to determine a voice quality of a voice call based on the calculated EMOS. In some embodiments, the method 200 generates a report of the determined voice quality, which allows the mobile network operator to make more informed decisions regarding whether service or maintenance of the network is warranted.

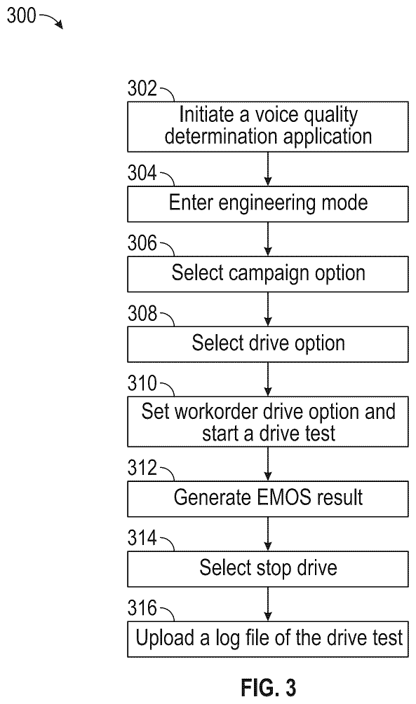

FIG. 3 is a flowchart of a method 300 of implementing a voice quality determination system to determine an Estimated Mean Opinion Score (EMOS) in accordance with some embodiments. In some embodiments, the method 300 is usable with the method 100 (FIG. 1) and/or method 200 (FIG. 2) by the mobile network operator to test a voice quality of a voice call made over a network. The method 300 is able to provide information to the mobile network operator based on collecting data from the mobile device and analyzing the data in real time. The method 300 provides a result of a value of EMOS, which allows the mobile network operator to make more informed decisions regarding whether service or maintenance of the network is warranted.

The method 300 includes operation 302 of initiating a voice quality determination application. In some embodiments, the application is installed in a memory of a mobile device or a memory of a chipset of a mobile device. The application is a testing application that is able to calculate an EMOS value with test call execution. In some embodiments, the application is usable by executing a test call, e.g., a call that originates from a mobile device (MO) and/or a call that terminates on a mobile device (MT).

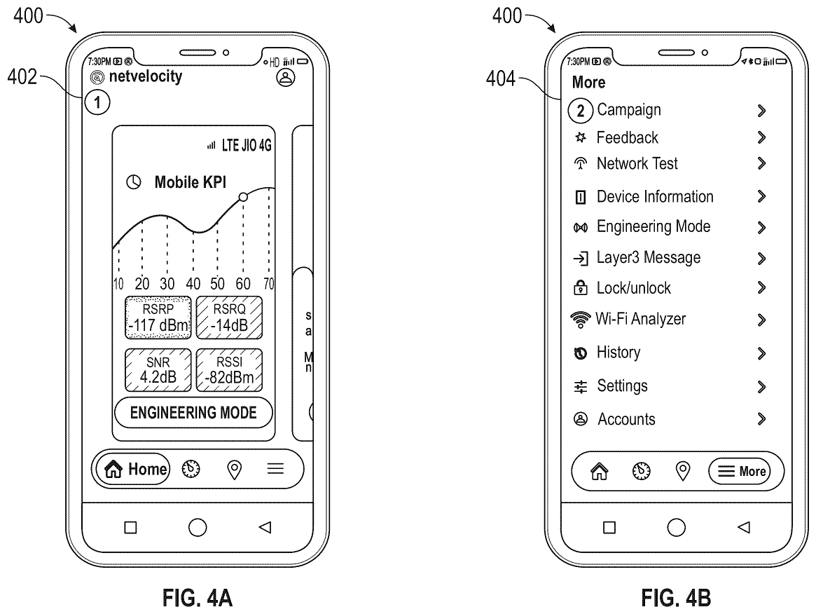

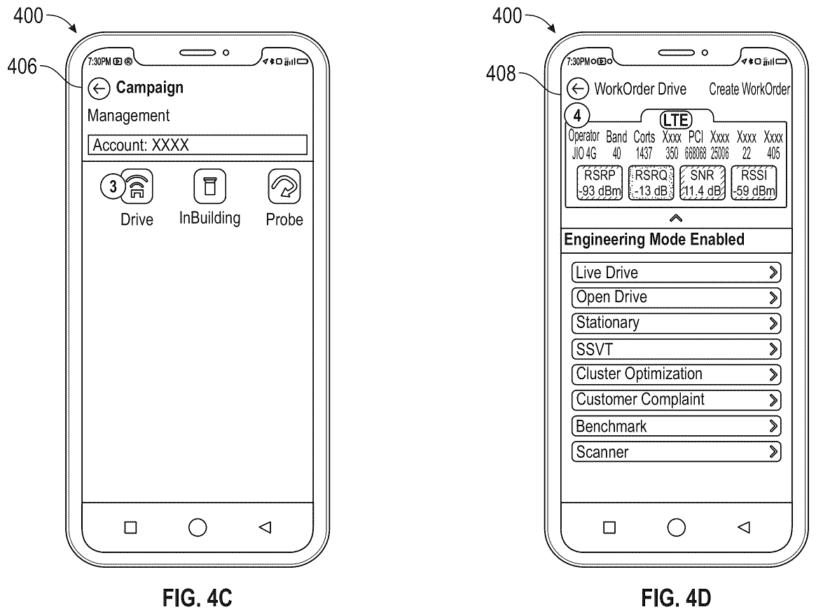

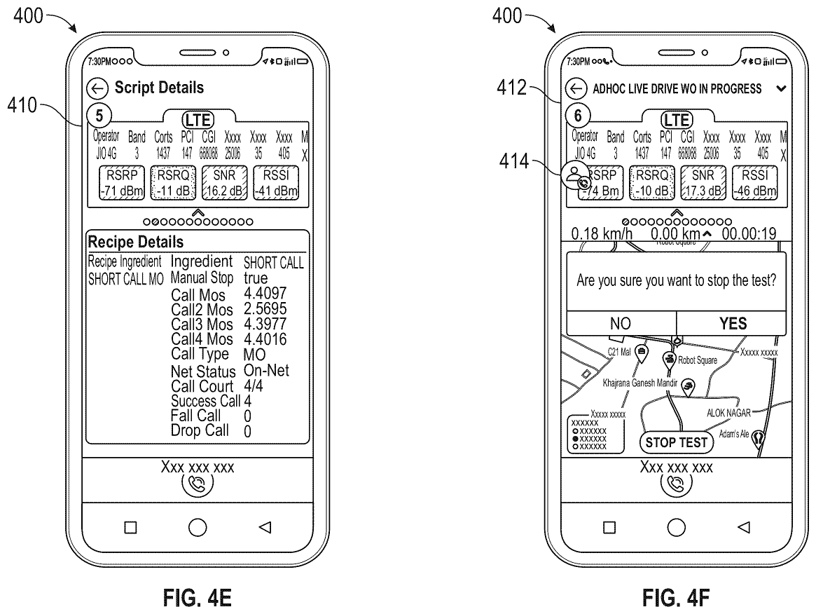

In response to the application being initiated in operation 302, the method 300 proceeds to operation 304 to enter an ENGINEERING MODE of the application. In some embodiments, the ENGINEERING MODE of the application monitors key performance indicators (KPIs) to determine a quality of a connection to the mobile device. In some embodiment, the application includes a further mode with a different functionality from the ENGINEERING MODE. The application includes a user interface displayed on a screen of a mobile device implementing the method 300. In some embodiments, a first screen showing the ENGINEERING MODE of the application is displayed as shown in FIG. 4A. In some embodiments, the ENGINEERING MODE is selectable by a gesture including, but not limited to, a touch, a click, or a press on a touch screen display. In some embodiments, the ENGINEERING MODE option is selectable by a voice command.

In response to the ENGINEERING MODE being entered in operation 304, the method 300 proceeds to operation 306 in which a CAMPAIGN option is selected. In some embodiments, in response to the selection of the ENGINEERING MODE, the first screen displaying the ENGINEERING MODE of the application is replaced with a second screen listing multiple functionality options under the ENGINEERING MODE. An example of the second screen is shown in FIG. 4B in accordance with some embodiments. The second screen includes a CAMPAIGN option for starting a voice call test. In some embodiments, the CAMPAIGN option is selectable by a gesture including, but not limited to, a touch, a click, or a press on a touch screen display. In some embodiments, the CAMPAIGN option is selectable by a voice command.

In response to the CAMPAIGN being selected in operation 306, the method 300 proceeds to operation 308. In operation 308, a third screen is displayed to show options associated with different testing methods under the CAMPAIGN option. In some embodiments, an example of the third screen is shown in FIG. 4C. In some embodiments, operation 308 selects a DRIVE option for testing a voice quality of a call made from a mobile device that travels from a start location to an end location at a map area covered by the network. In some embodiments, operation 308 selects a different option, for instance, an INBUILDING option for testing a voice quality of a call made inside a building covered by the network, or a PROBE option for testing a voice quality of a call made at one or more locations at a map area covered by the network. In some embodiments, when the PROBE option is selected, multiple probes are set at multiple locations, and in a voice quality call test under the PROBE option, when the multiple probes are executing call recipes each of which includes a predetermined set of parameters of instructions that indicate the specifics of the call test, a value of EMOS corresponding to each probe is calculated. In some embodiments, the selection is made in operation 308 by a gesture including, but not limited to, a touch, a click, or a press on a touch screen display. In some embodiments, the selection in operation 308 is made by a voice command.

In response to the DRIVE option being selected in operation 308, the method 300 proceeds to operation 310 in which a WORKORDER DRIVE option is selected and a drive test is started. The WORKORDER DRIVE refers to a workorder set for implementing a corresponding drive test. A plurality of workorders are able to be set for implementing corresponding drive tests, and each of the workorders is assigned with a unique ID. In some embodiments, operation 310 displays a fourth screen of the application indicating that the WORKORDER DRIVE option is selected. In some embodiments, an example of the fourth screen is shown in FIG. 4D. In some embodiments, the WORKORDER DRIVE option is selectable by a gesture including, but not limited to, a touch, a click, or a press on a touch screen display. In some embodiments, the WORKORDER DRIVE option is selectable by a voice command.

Further, in operation 310, a notification is generated to indicate that the drive test is started in accordance with some embodiments. In some embodiments, the fourth screen indicates that the drive test is started by displaying a message in a pop-up window or at a notification bar. In some embodiments, a notification is generated in a form of sound or vibration of the mobile device implementing the application.

In response to the drive test being started in operation 310, the method 300 proceeds to operation 312 in which a result of a determined EMOS value is generated. In some embodiments, the result of the determined EMOS value is generated based on data collected from one or more test calls made during the drive test started in operation 310. In some embodiments, the EMOS value is determined in accordance with the method 100 (FIG. 1) and/or the method 200 (FIG. 2). In some embodiments, a result of the determined EMOS value(s) is displayed at a fifth screen that includes call script details. In some embodiments, an example of the fifth screen is shown in FIG. 4E.

In some embodiments, the result of the determined EMOS value includes one or more EMOS values determined from one or more calls. In some embodiments, in response to more than one call is made during the drive test in operation 310, a result of a determined EMOS value corresponding to each of the calls is generated together in operation 312. In some embodiments, a result of a determined EMOS value corresponding to a test call during the drive test is generated automatically in response to a call is stopped manually or unintentionally.

In response to the EMOS result being generated in operation 312, the method 300 proceeds to operation 314 in which a STOP DRIVE option is selected. In some embodiments, in operation 314, a prompt is provided to a user to select for stopping the drive test. In some embodiments, in response to that the EMOS result is generated in operation 312, the prompt is displayed on a sixth screen automatically without user interaction. An example of the sixth screen is shown in FIG. 4F. In some embodiments, operation 314 stops the drive test by selecting the STOP DRIVE option on the screen or by a voice command.

In response to the drive test being stopped in operation 314, the method 300 proceeds to operation 316 in which a log file of the drive test is uploaded to an external device, e.g., a server. In some embodiments, a log file including information related to the drive test is transmitted by a transmitter to a server of the mobile network provider for monitoring, optimizing or improving the performance of the application. In some embodiments, a log file including a result of the drive test is provided to the mobile network provider for analysis and better decision making.

One of ordinary skill in the art would recognize that additional operations are included in method 300 in some embodiments. For example, in some embodiments, the method 300 further includes an operation of generating an alert or notification in response to a result indicating a poor voice quality at the drive test. In some embodiments, at least one operation is omitted from the method 300. For example, in some embodiments, the drive test is automatically terminated in response to a number of dropped calls being greater than a predetermined threshold. In such a case, the operation 314 of selecting STOP DRIVE option is omitted from the method 200. In some embodiments, an order of operations of the method 300 is adjusted. For example, in some embodiments, operation 308 of selecting DRIVE option is performed prior to operation 306.

In accordance with some embodiments described in the disclosure, the method 300 is able to conduct a work order-based drive test for capturing engineering details of a network condition. In some embodiments, the method 300 is able to synchronize network data to a server of the mobile network operator in near real-time to make data accessible for analysis and decision making. In some embodiments, the method 300 uses the method 100 (FIG. 1) and/or the method 200 (FIG. 2) to calculate an EMOS value which indicates a quality of a voice call. As such, the method helps the mobile network operator for a faster decision-making, therefore efficiency in maintaining the network is improved or customer satisfaction is maintained or improved.

FIGS. 4A-4F are diagrams of a user interface of a voice quality determination system 400 in accordance with some embodiments.

FIG. 4A is a diagram illustrating an example of a user interface of the voice quality determination system 400 in accordance with some embodiments. The user interface includes a first screen 402. The first screen 402 is a home page of the user interface of the voice quality determination system. The first screen 402 shows an ENGINEERING MODE which is a selectable icon. In some embodiments, the first screen 402 further shows metrics used to measure the quality of the network under the ENGINEERING MODE. The metrics include, but not limited to, Reference Signal Received Power (RSRP), Reference Signal Received Quality (RSRQ), Signal-to-Noise Ratio (SNR), and Received Signal Strength Indicator (RSSI). In some embodiments, other metrics are included and measured/monitored under the ENGINEERING MODE.

FIG. 4B is a diagram illustrating an example of a user interface of the voice quality determination system 400 in accordance with some embodiments. The user interface includes a second screen 404 displaying a list of selectable icons. In some embodiments, the selectable icons include, but not limited to, “CAMPAIGN.” “FEEDBACK,” “NETWORK TEST.” “DEVICE INFORMATION,” “ENGINEERING MODE,” “LAYER3 MESSAGE,” “LOCK/UNLOCK,” “WIFI ANALYZER,” “HISTORY,” “SETTINGS,” and “ACCOUNTS.” The second screen 404 allows the user of the voice quality determination system to select any of the above options. In some embodiments, the CAMPAIGN option is selected to proceed with a drive test for determining a quality of a voice call.

FIG. 4C is a diagram illustrating an example of a user interface of the voice quality determination system 400 in accordance with some embodiments. The user interface includes a third screen 406 includes management information of the CAMPAIGN, for instance, an account information. In some embodiments, the third screen 406 further displays selectable icons “DRIVE,” “INBUILDING,” and “PROBE” for different test execution. The “DRIVE” icon is selectable for testing a voice quality of a call made from a mobile device that travels from a start location to an end location at a map area covered by the network. The “INBUILDING” icon is selectable for testing a voice quality of a call made inside a building covered by the network. The “PROBE” icon is selectable for testing a voice quality of a call made at one or more locations at a map area covered by the network. In some embodiments, when the PROBE option is selected, multiple probes are set at multiple locations, and in a voice quality call test under the PROBE option, when the multiple probes are executing call recipes each of which includes a predetermined set of parameters of instructions that indicate the specifics of the call test, a value of EMOS corresponding to each probe is calculated.

FIG. 4D is a diagram illustrating an example of an interface of the voice quality determination system 400 in accordance with some embodiments. The interface includes a fourth screen 408. The fourth screen 408 indicates a type of the network being tested, e.g., a LTE network. In some embodiments, the fourth screen 408 includes metrics information indicating the signal strength and quality of the network, which is are similarly included in the home page of the first screen 402 (FIG. 4A). In some embodiments, the fourth screen 408 indicates whether the ENGINEERING MODE is enabled. In some embodiments, the fourth screen 408 further displays a list of selectable engineering tools. The functions include “Live Drive,” “Open Drive,” “Stationary,” “SSVT,” “Cluster Optimization,” “Customer Complaint,” “Benchmark,” and “Scanner.” In some embodiments, the “Live Drive” detects, monitors, measures data of a live drive test. The “OPEN DRIVE” opens a file of a previous drive test and allows the user to select, review, and obtain information of the previous drive test. In some embodiments, the “Stationary” detects, monitors, measures data of a voice call by a stationary test, i.e., without driving. In some embodiments, the “SSVT” conducts a Single Site Verification Test to measure the quality of a voice call on a single network site or location. In some embodiments, the “Cluster Optimization” optimizes performance and efficiency of a cluster of network devices or components. In some embodiments, the “Customer Complaint” allows the user to view a history of customer complaint about the network performance. In some embodiments, the “Benchmark” measures and compares the performance of equipment, systems, or networks with other similar equipment, systems, or networks to identify areas for improvement. In some embodiments, the “Scanner” identifies and analyzes radio frequency signals.

FIG. 4E is a diagram illustrating an example of an interface of the voice quality determination system 400 in accordance with some embodiments. The interface includes a fifth screen 410 that displays a result of the drive test. The result of the drive test includes calculated MOS or EMOS values corresponding to the calls made during the drive test. For example, referring to FIG. 4E, for a drive test including four calls, a result of the drive test shows that call 1 has a MOS value of 4.4097, call 2 has a MOS value of 2.5695, call 3 has a MOS value of 4.3977, and call 4 has a MOS value of 4.4016. In some embodiments, the MOS values are calculated or determined according to the method 100 (FIG. 1) or the method 200 (FIG. 2). In some embodiments, the fifth screen 410 further displays Recipe Details including the type of calls, whether there is a stop at the drive test, a status of the network, the number of success calls, the number of fail calls, and the number of drop calls.

FIG. 4F is a diagram illustrating an example an interface of the voice quality determination system 400 in accordance with some embodiments. The interface includes a sixth screen 412. In some embodiments, the sixth screen 412 displays an icon 414 indicating a call being in progress. In some embodiments, when a selection of the icon 414 is made, a prompt is displayed in the sixth screen 412 to ask the user whether to stop the test. In some embodiments, when there is no voice communication in progress anymore, the prompt is displayed automatically without user interaction.

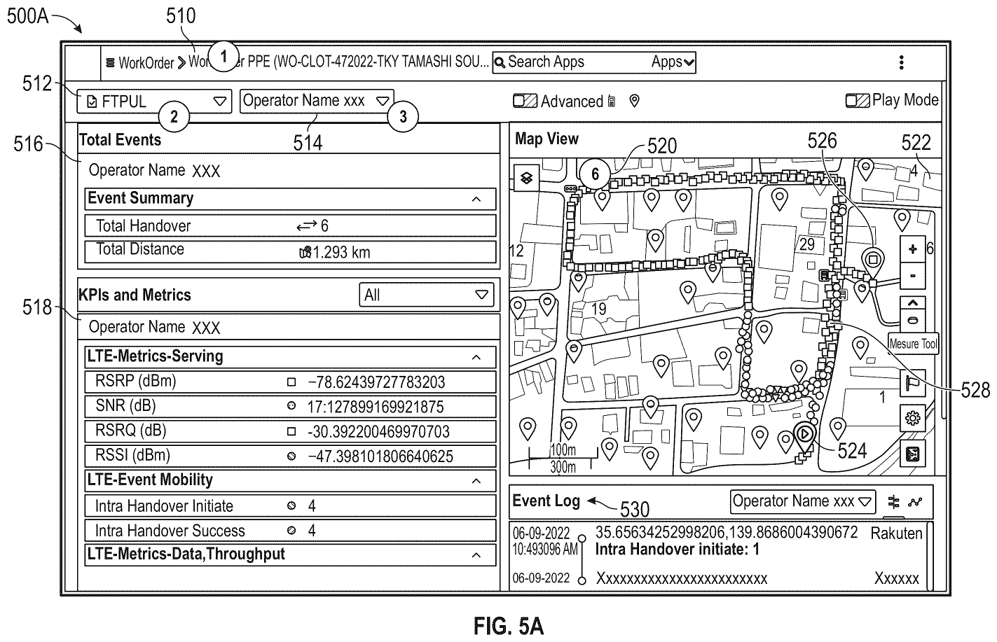

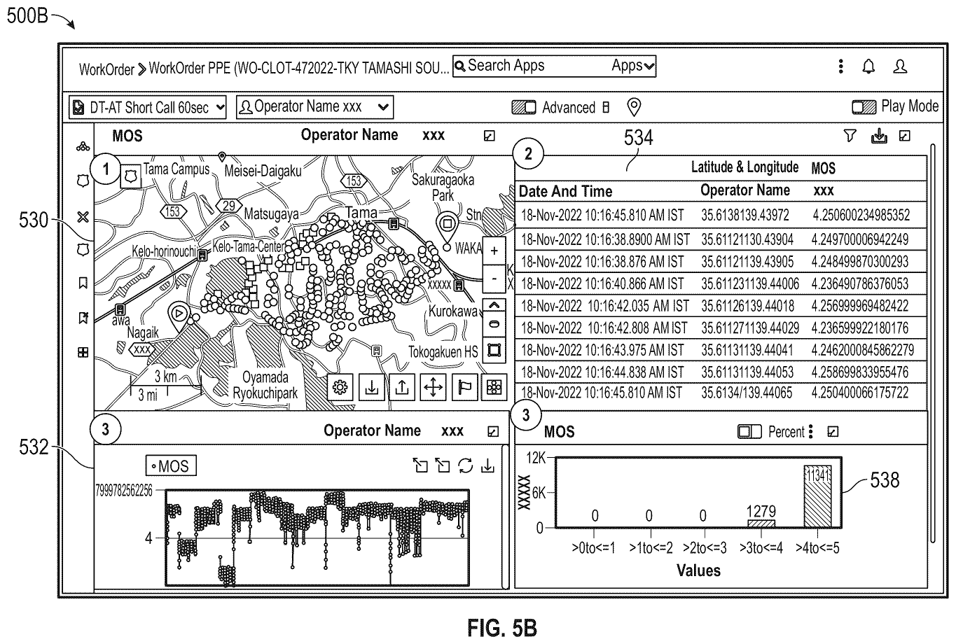

FIG. 5A is a diagram illustrating an example of a further user interface of a voice quality determination system in accordance with some embodiments. The user interface includes a screen 500A. The screen 500A displays details of a test executed for determining a quality of a voice call made over the network. In some embodiments, the screen 500A displays a normal mode view that provides information of the test after the test is executed.

In some embodiments, the screen 500A includes work order ID and work order name 510 on a top left side of the screen. The work order ID and work order name correspond to an executed test, e.g., a drive test. Further, the screen 500A includes a drop-down list 512 including a set of files transmitted over the network under the work order ID. For instance, the file “FTP UL”, i.e., “File Transfer Protocol Uplink”, indicates data transmitted from a mobile originated device to an external device, e.g., a server. The screen 500A further shows a name 514 of the mobile network operator corresponding to the selected file. This allows the user to choose the particular work order to see the details of the test made in the particular work order.

The screen 500A further includes a Total Events section 516. In some embodiments, an Event Summary is provided in the Total Events section 516. In some embodiments, the Event Summary includes “Total Handover” and “Total Distance.” The “Total Handover” indicates the number of handover processes occurred at the corresponding drive test. The “Total Distance” indicates a total distance from a start location of the drive test to a stop location of the drive test.

The screen 500A further includes a KPIs and Metrics section 518. In some embodiments, the KPIs and Metrics section 518 includes average data of basic serving KPIs and an event count. For instance, the average data of the basic serving KPIs includes data for RSRP. SNR. RSRQ, and RSSI, and the event count includes the number of initiated handover and the number of success handover. In some embodiments, the KPIs and Metrics section 518 includes other metrics data for indicating the quality of the network. In some embodiments, the other metrics data is selectively shown on the screen 500.

Further, a map view 520 is included in the screen 500A. At the map view 520, a map 522 of the corresponding drive test executed is displayed. Further, a start location of the corresponding drive test is shown by an icon 524, a stop location of the corresponding drive test is shown by another icon 526, and a driving route 528 is displayed. The icons 524 and 526 are displayed in different manner, e.g., by different colors, shapes, or other designs. In some embodiments, different filters are selectable under the map view 520 to display a result of the KPI data, such as the initiated handovers and the successful handovers. For instance, the initiated handovers and the successful handovers are displayed on the driving route 528 with different colors or patterns. In some embodiments, the user is allowed to set a preferred color or pattern for displaying the KPI data or other metrics data. Further, an Event Log section 530 is provided adjacent to the map view 520. The Event Log section 530 provides details of the log data, such as date, time, a flow of the drive test, and the name of mobile network operator, etc.

FIG. 5B is a diagram illustrating an example of a further user interface of a voice quality determination system in accordance with some embodiments. The user interface includes a screen 500B that displays details of a drive test executed for determining a quality of a voice call made over the network. In some embodiments, the screen 500B displays an advanced mode view that provides the determined MOS information after the drive test is executed.

The screen 500B provides views for the user to select and see the determined MOS information in different manner. In some embodiments, the screen 500B includes a Map view 522, a Table view 532, a line Chart view 534, and a Column chart view 538. In response to selecting checkboxes corresponding to the Map view 522, the Table view 532, the line Chart view 534, and the Column chart view 538, the screen 500B displays plotted MOS data of the drive test on the Map view 522, the Table view 532, the line Chart view 534, and the Column chart view 538, respectively. In some embodiments, additional views are selectable to plot the MOS data. In some embodiments, only one or two views are selected to plot the MOS data.

In accordance with some embodiments described in the disclosure, the interfaces or screens 500A and 500B of the voice quality determination system are provided for a user to see details of a drive test and a result of a calculated EMOS or MOS value for determining a quality of a voice call. In some embodiments, the drive test is implemented by the method 300 (FIG. 3) and the EMOS value is calculated by the method 100 (FIG. 1) and/or the method 200 (FIG. 2). In some embodiments, the voice quality determination system provides a secured link or a passcode to one or more users. In such a case, the users are allowed to see the details of the drive test from the users' own devices without paying and installing a licensed software/application on their own devices. The interface helps the user grasp the details of the drive test and identify any issues/problems that require a fix. Therefore, efficiency in maintaining the network is improved or customer satisfaction is maintained or improved.

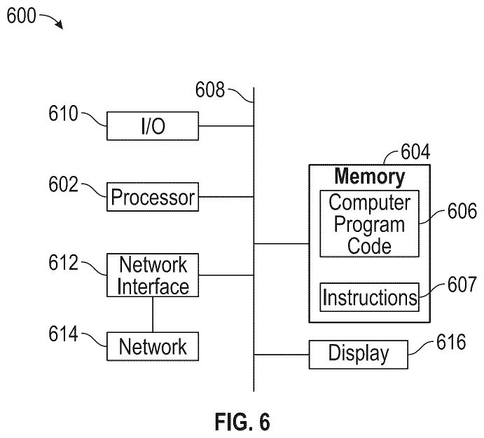

FIG. 6 is a block diagram of a system 600 for implementing determination of a quality of a voice call in accordance with some embodiments. System 600 includes a hardware processor 602 and a memory 604 which is a non-transitory, computer readable storage medium encoded with, i.e., storing, computer program code 606, i.e., a set of executable instructions. The processor 602 is electrically coupled to the memory 604 via a bus 608. The processor 602 is also electrically coupled to an I/O interface 610 by bus 608. A network interface 612 is also electrically connected to the processor 602 via bus 608. Network interface 612 is connected to a network 614, so that processor 602 and computer readable storage medium 604 are capable of connecting to external elements via network 614. The processor 602 is configured to execute the computer program code 606 encoded in the memory 604 in order to cause system 600 to be usable for performing a portion or all of the operations as described in method 100 (FIG. 1), method 200 (FIG. 2), or method 300 (FIG. 3).

In some embodiments, the processor 602 is a central processing unit (CPU), a multi-processor, a distributed processing system, an application specific integrated circuit (ASIC), and/or a suitable processing unit.

In some embodiments, the memory 604 is an electronic, magnetic, optical, electromagnetic, infrared, and/or a semiconductor system (or apparatus or device). For example, the memory 604 includes a semiconductor or solid-state memory, a magnetic tape, a removable computer diskette, a random access memory (RAM), a read-only memory (ROM), a rigid magnetic disk, and/or an optical disk. In some embodiments using optical disks, the memory 604 includes a compact disk-read only memory (CD-ROM), a compact disk-read/write (CD-R/W), and/or a digital video disc (DVD).

In some embodiments, the memory 604 stores the computer program code 606 configured to cause system 600 to perform a portion or all of the operations as described in method 100 (FIG. 1), method 200 (FIG. 2), or method 300 (FIG. 3). In some embodiments, the memory 604 also stores information for performing a portion or all of the operations as described in method 100 (FIG. 1), method 200 (FIG. 2), or method 300 (FIG. 3) as well as information generated during performing a portion or all of the operations as described in method 100 (FIG. 1), method 200 (FIG. 2), or method 300 (FIG. 3), such as values of parameter R, Rₒ, I_{dh}, Iₑ and/or a set of executable instructions to perform a portion or all of the operations as described in method 100 (FIG. 1), method 200 (FIG. 2), or method 300 (FIG. 3). In some embodiments, the memory 604 further stores information for interfacing as described with respect to FIGS. 4A-4F and FIGS. 5A-5B.

In some embodiments, the memory 604 stores instructions 607 for interfacing with an external device. The instructions 607 enable processor 602 to generate and receive instructions readable by the external device to effectively perform a portion or all of the operations as described in method 100 (FIG. 1), method 200 (FIG. 2), or method 300 (FIG. 3).

System 600 includes I/O interface 610. I/O interface 610 is coupled to external circuitry. In some embodiments, I/O interface 610 includes a keyboard, keypad, mouse, trackball, trackpad, and/or cursor direction keys for communicating information and commands to processor 602.

System 600 also includes network interface 612 coupled to the processor 602. Network interface 612 allows system 600 to communicate with network 614, to which one or more other computer systems are connected. Network interface 412 includes wireless network interfaces such as BLUETOOTH, WIFI, WIMAX, GPRS, or WCDMA; or wired network interface such as ETHERNET, USB, or IEEE-1394. In some embodiments, method 100 (FIG. 1), method 200 (FIG. 2), or method 300 (FIG. 3) is implemented in two or more systems 600, and information is exchanged between different systems 600 via network 614.

System 600 includes display 616. The display 616 is electrically connected to the processor 602, memory 604, and I/O 610 via bus 608. The display 616 is a touch screen display provided with a display device such as a liquid crystal display (LCD), a light-emitting diodes (LED) display, or an organic light-emitting diode (OLED or organic LED). The display 616 displays one or more user interfaces or screens 402, 404, 406, 408, 410, 412 (FIGS. 4A-4F) and user interfaces or screens 500A (FIG. 5A) and 500B (FIG. 5B). The display 616 is further provided with a touch screen that detects a contact of a finger, a pen, a stylus pen or the like on the touch screen. The contact includes, but not limited to, touch, long touch, release, swipe, tap, double tap, and long tap.

### Supplemental Note 1

An aspect of this description relates to a voice quality determination system. The voice quality determination system includes a display; a non-transitory computer readable medium configured to store instructions thereon; and a processor connected to the non-transitory computer readable medium and the display. The processor is configured to execute the instructions for receiving voice data of a voice call made over a network of a mobile network operator, the voice data being divided into packets for transmission in the network. The processor is configured to execute the instructions for, in response to receiving the voice data, determining a voice quality of the voice call based on: a packet loss indicating a packet of the packets failing to be transmitted during the transmission and a delay that occurred during the transmission. The processor is further configured to execute the instructions for instructing the display to display a result of a determination of the voice quality.

### Supplemental Note 2

In some embodiments, the processor of the Supplemental Note 1 is configured to execute the instructions for determining the delay that includes an average frame delay referring to an average time for transmitting a frame of the voice data to a destination.

### Supplemental Note 3

In some embodiments, the processor of the Supplemental Notes 1 and 2 is configured to execute the instructions for determining the delay that further includes a packetization delay referring to a time for dividing the voice data into the packets and transmitting the packets using the network.

### Supplemental Note 4

In some embodiments, the processor of any of Supplemental Notes 1-3 is configured to execute the instructions for determining the delay that further includes a processing delay referring to a time for processing the voice data.

### Supplemental Note 5

In some embodiments, the processor of any of Supplemental Notes 1-4 is configured to execute the instructions for determining the delay by adding the average frame delay, the packetization delay, and the processing delay.

### Supplemental Note 6

In some embodiments, the processor of any of Supplemental Notes 1-5 is configured to execute the instructions for calculating a packet loss percentage obtained by dividing a total number of the packets by a number of lost packets during the transmission, as the packet loss.

### Supplemental Note 7

In some embodiments, the processor of any of Supplemental Notes 1-6 is configured to execute the instructions for calculating a value indicating an effectiveness of equipment of the mobile network operator at the transmission based on the packet loss and a predetermined parameter value associated with the equipment of the mobile network operator.

### Supplemental Note 8

In some embodiments, the processor of any of Supplemental Notes 1-7 is configured to execute the instructions for calculating an R factor according to a formula (i): R=Rₒ−I_{dh}−Iₑ to determine the voice quality of the voice call, where Rₒ is a signal to noise ratio, I_{dh} is a value of the delay occurred during the transmission, and Iₑ is a value indicating an effectiveness of equipment of the mobile network operator at the transmission.

### Supplemental Note 9

In some embodiments, the processor of any of Supplemental Notes 1-8 is configured to execute the instructions for calculating the value indicating the effectiveness of the equipment of the mobile network operator at the transmission based on the packet loss and a predetermined parameter value associated with the equipment of the mobile network operator.

### Supplemental Note 10

In some embodiments, the processor of any of Supplemental Notes 1-9 is configured to execute the instructions for calculating the value of the delay by considering at least one of: an average frame delay referring to an average time for a frame of the voice data transmitted during the transmission, a packetization delay referring to a time for dividing the voice data into the packets and transmitting the packets in the network, or a processing delay referring to a time for processing the voice data as the voice data being transmitted in the network.

### Supplemental Note 11

In some embodiments, the processor of any of Supplemental Notes 1-10 is configured to execute the instructions for determining the delay by adding the average frame delay, the packetization delay, and the processing delay.

### Supplemental Note 12

In some embodiments, the processor of any of Supplemental Notes 1-11 is configured to execute the instructions for calculating an estimated Mean Opinion Score (EMOS) based on a formula (ii): EMOS=1+(0.035×R)+R×(R−60)×(100−R)×7\hat{ }(−6), where R is the calculated R factor, and the processor is configured to execute the instructions for determining the voice quality of the voice call based on a value of the estimated Mean Opinion Score.

### Supplemental Note 13

In some embodiments, the processor of any of Supplemental Notes 1-12 is configured to execute the instructions for instructing a transmitter to transmit the result of the determination of the voice quality to a server.

### Supplemental Note 14

An aspect of this description relates to a voice quality determination method. The voice quality determination method includes receiving voice data of a voice call made over a network of a mobile network operator, the voice data being divided into packets for transmission in the network. The method further includes in response to receiving the voice data, determining a voice quality of the voice call based on a packet loss indicating a packet of the packets failing to be transmitted during the transmission and a delay that occurred during the transmission. The method further includes displaying a result of a determination of the voice quality.

### Supplemental Note 15

In some embodiments, the method of the Supplemental Note 14 further includes calculating an R factor according to a formula (i): R=Rₒ−I_{dh}−Iₑ to determine the voice quality of the voice call, where Rₒ is a signal to noise ratio, Ian is a value of the delay that occurred during the transmission, and Iₑ is a value indicating an effectiveness of equipment of the mobile network operator at the transmission.

### Supplemental Note 16

In some embodiments, the method of the Supplemental Notes 14 and 15 further includes calculating the value indicating the effectiveness of the equipment of the mobile network operator at the transmission based on the packet loss and a predetermined parameter value associated with the equipment of the mobile network operator.

### Supplemental Note 17

In some embodiments, the method of any of the Supplemental Notes 14-16 further includes calculating the value of the delay by considering at least one of: an average frame delay referring to an average time for transmitting a frame of the voice data to reach a destination, a packetization delay referring to a time for dividing the voice data into the packets and transmitting the packets in the network, or a processing delay referring to a time for processing the voice data.

### Supplemental Note 18

In some embodiments, the method of any of the Supplemental Notes 14-17 further includes calculating an Estimated Mean Opinion Score (EMOS) based on a formula (ii): EMOS=1+(0.035×R)+R×(R−60)×(100−R)×7\hat{ }(−6), where R is the calculated R factor; and determining the voice quality of the voice call based on a value of the Estimated Mean Opinion Score.

### Supplemental Note 19

In some embodiments, the method of any of the Supplemental Notes 14-18 further includes transmitting the result of the determination of the voice quality to a server.

An aspect of this description relates to a non-transitory computer readable medium configured to store instructions for causing a processor executing the instructions to implement a voice quality determination method. The instructions cause the processor to receive voice data of a voice call made over a network of a mobile network operator, the voice data being divided into packets for transmission in the network. The instructions further cause the processor to, in response to receiving the voice data, determine a voice quality of the voice call based on a packet loss indicating a packet of the packets failing to be transmitted during the transmission and a delay that occurred during the transmission. The instructions further cause the processor to displaying a result of a determination of the voice quality.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A voice quality determination system comprising:
a display;
a non-transitory computer readable medium configured to store instructions thereon; and
a processor connected to the non-transitory computer readable medium, wherein the processor is configured to execute the instructions for:
receiving voice data of a voice call made over a network of a mobile network operator, the voice data being divided into packets for transmission in the network;
in response to receiving the voice data, determining a voice quality of the voice call based on:
a packet loss indicating a packet of the packets failing to be transmitted during the transmission; and
a delay that occurred during the transmission; and
instructing the display to display a result of a determination of the voice quality.

2. The voice quality determination system according to claim 1, wherein the processor is configured to execute the instructions for determining the delay that includes an average frame delay referring to an average time for transmitting a frame of the voice data to a destination.

3. The voice quality determination system according to claim 2, wherein the processor is configured to execute the instructions for determining the delay that further includes a packetization delay referring to a time for dividing the voice data into the packets and transmitting the packets using the network.

4. The voice quality determination system according to claim 3, wherein the processor is configured to execute the instructions for determining the delay that further includes a processing delay referring to a time for processing the voice data.

5. The voice quality determination system according to claim 4, wherein the processor is configured to execute the instructions for determining the delay by adding the average frame delay, the packetization delay, and the processing delay.

6. The voice quality determination system according to claim 1, wherein the processor is configured to execute the instructions for calculating a packet loss percentage obtained by dividing a total number of the packets by a number of lost packets during the transmission, as the packet loss.

7. The voice quality determination system according to claim 1, wherein the processor is configured to execute the instructions for calculating a value indicating an effectiveness of equipment of the mobile network operator at the transmission based on the packet loss and a predetermined parameter value associated with the equipment of the mobile network operator.

8. The voice quality determination system according to claim 1, wherein the processor is configured to execute the instructions for calculating an R factor according to a formula (i):
R=Rₒ−I_{dh}−Iₑ to determine the voice quality of the voice call, where
Rₒ is a signal to noise ratio,
I_{dh} is a value of the delay occurred during the transmission, and
Iₑ is a value indicating an effectiveness of equipment of the mobile network operator at the transmission.

9. The voice quality determination system according to claim 8, wherein the processor is configured to execute the instructions for calculating the value indicating the effectiveness of the equipment of the mobile network operator at the transmission based on the packet loss and a predetermined parameter value associated with the equipment of the mobile network operator.

10. The voice quality determination system according to claim 8, wherein
the processor is configured to execute the instructions for calculating the value of the delay by considering at least one of:
an average frame delay referring to an average time for a frame of the voice data transmitted during the transmission,
a packetization delay referring to a time for dividing the voice data into the packets and transmitting the packets in the network, or
a processing delay referring to a time for processing the voice data.

11. The voice quality determination system according to claim 10, wherein the processor is configured to execute the instructions for determining the delay by adding the average frame delay, the packetization delay, and the processing delay.

12. The voice quality determination system according to claim 8, wherein
the processor is configured to execute the instructions for calculating an estimated Mean Opinion Score (EMOS) based on a formula (ii): EMOS=1+(0.035×R)+R×(R−60)×(100−R)×7\hat{ }(−6), where R is the calculated R factor, and
the processor is configured to execute the instructions for determining the voice quality of the voice call based on a value of the estimated Mean Opinion Score.

13. The voice quality determination system according to claim 1, wherein the processor is configured to execute the instructions for instructing a transmitter to transmit the result of the determination of the voice quality to a server.

14. A voice quality determination method comprising:
receiving voice data of a voice call made over a network of a mobile network operator, the voice data being divided into packets for transmission in the network;
in response to receiving the voice data, determining a voice quality of the voice call based on:
a packet loss indicating a packet of the packets failing to be transmitted during the transmission; and
a delay that occurred during the transmission; and
displaying a result of a determination of the voice quality.

15. The voice quality determination method according to claim 14, further comprising calculating an R factor according to a formula (i): R=Rₒ−I_{dh}−Iₑ to determine the voice quality of the voice call, where
Rₒ is a signal to noise ratio,
I_{dh} is a value of the delay occurred during the transmission, and
Iₑ is a value indicating an effectiveness of equipment of the mobile network operator at the transmission.

16. The voice quality determination method according to claim 15, further comprising:
calculating the value indicating the effectiveness of the equipment of the mobile network operator at the transmission based on the packet loss and a predetermined parameter value associated with the equipment of the mobile network operator.

17. The voice quality determination method according to claim 15, further comprising:
calculating the value of the delay by considering at least one of:
an average frame delay referring to an average time for transmitting a frame of the voice data to a destination,
a packetization delay referring to a time for dividing the voice data into the packets and transmitting the packets in the network, or
a processing delay referring to a time for processing the voice data.

18. The voice quality determination method according to claim 15, further comprising:
calculating an Estimated Mean Opinion Score (EMOS) based on a formula (ii):
$$EMOS = 1 + ( 0.0 \; 35 \times R ) + R \times ( R - 60 ) \times ( 100 - R ) \times 7 \hat{} ( - 6 ) ,$$
where R is the calculated R factor; and
determining the voice quality of the voice call based on a value of the Estimated Mean Opinion Score.

19. The voice quality determination method according to claim 15, further comprising:
transmitting the result of the determination of the voice quality to a server.

20. A non-transitory computer readable medium configured to store instructions for causing a processor executing the instructions to implement a voice quality determination method comprising:
receiving voice data of a voice call made over a network of a mobile network operator, the voice data being divided into packets for transmission in the network;
in response to receiving the voice data, determining a voice quality of the voice call based on:
a packet loss indicating a packet of the packets failed to be transmitted during the transmission; and
a delay that occurred during the transmission; and
displaying a result of a determination of the voice quality.
